(19) United States
(12) Patent Application Publication
(10) Pub. No.: US 2007/0217887 A1
(43) Pub. Date: Sep. 20, 2007

(54) Screw

(76) Inventor: Ching-Kuei Lin, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/376,223

(22) Filed: Mar. 16, 2006

(51) Int. Cl. F16B 35/04

(52) U.S. Cl. 411/413

(57) ABSTRACT

A screw includes a head and a shank extending down from the head. The shank is provided with a first clockwise-threaded portion from an intermediate portion to the bottom end, a counterclockwise-threaded portion the upper end of the first clockwise-threaded portion to the head, and a second clockwise-threaded portion formed in a lower end section of the first clockwise-threaded portion and having one-third length of the clockwise-threaded portion and threads between two threads of the first clockwise-threaded portion. Therefore, the lower end section of the shank has a smaller pitch able to permit the screw move into articles more easily and rapidly. Moreover, the counterbalancing function of the clockwise and the counterclockwise threads can keep the screw buried in the articles more stably without loosening easily.

### BACKGROUND OF THE INVENTION

1. Field of the Invention

This invention relates to a screw, particularly to one able to save power and to be screwed with articles stable and not easily loosen off.

2. Description of the Prior Art

Usually, a screw is used to keep non-metallic articles that are made of plastics or wood etc. fastened together via screwing it directly into them. Because a screw has a higher harness than the articles to be screwed, it can be screwed into the articles to squeeze and form threaded grooves inside them, so as to keep the articles tightly fastened together by the screw. But, while a conventional screw is screwed into articles deeper and deeper, it is to encounter a counter force caused by the articles, because the articles are only squeezed not cut. So the deeper the screw is forced in, the more the contacting area between the screw and the articles is increased. So a user always has to gradually exercise more power, taking a long time to keep screw a conventional screw into articles completely.

### SUMMARY OF THE INVENTION

The objective of this invention is to offer a screw improved than convention ones.

The main characteristics of the invention are a head and a shank extending down from the head. The shank formed round or triangular is provided with a first clockwise-threaded portion located from an intermediate portion to a lower end, a counterclockwise-threaded portion located from the upper end of the first clockwise-threaded portion to the head, and a second clockwise-threaded portion on a lower end section of the first clockwise-treaded portion and having one-third length of the first clockwise-threaded portion and threads between two threads of the first clockwise-threaded portion. Therefore, the lower end section of the shank has double threads of a smaller pitch, able to permit the screw move into articles more easily and rapidly. Moreover, the counterbalancing function of the clockwise and the counterclockwise threads can keep the screw buried in the articles more stably, preventing the screw from loosening off articles by non-manual factor.

### BRIEF DESCRIPTION OF DRAWINGS

This invention is better understood by referring to the accompanying drawings, wherein:

FIG. 1 is a perspective view of a preferred embodiment of a screw in the present invention;

FIG. 2 is a cross-sectional view of the preferred embodiment of a screw in the present invention;

FIG. 3 is an upper view of the preferred embodiment of a screw in the present invention; and

FIG. 4 is also an upper perspective view of the preferred embodiment of a screw in the present invention.

### DETAILED DESCRIPTION OF THE PREFERRED EMBODIMENT

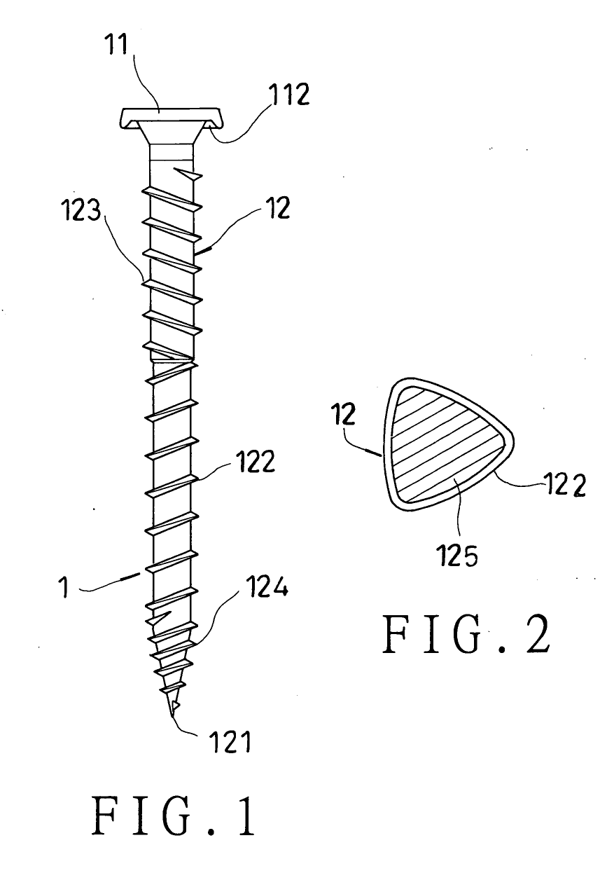

As shown in FIG. 1, a first preferred embodiment of a screw 1 in the present invention includes a head 11 and a shank 12 extending down from the head 11.

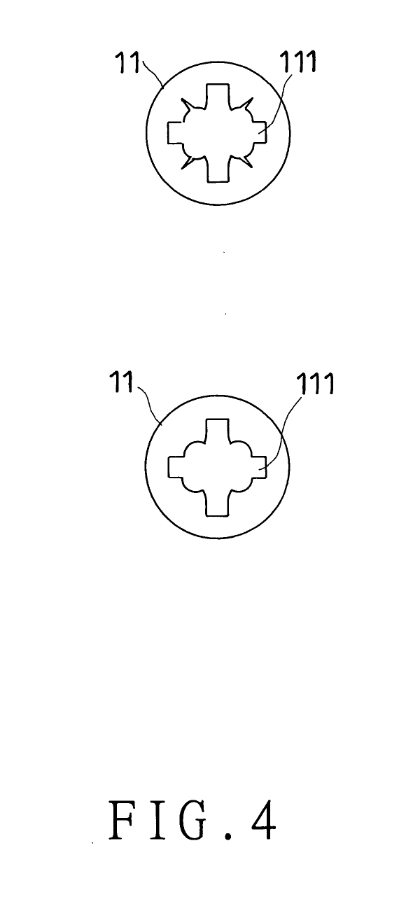

The head 11 is provided with a recess 111 in the top surface for a tool such as a screwdriver to fit closely in, as shown in FIGS. 3 and 4, and an annular groove 112 formed around the circumference of the bottom to shape the head 11 as a reverse U in a cross-sectional view.

The shank 12 is provided with a conical sharp point 121 at the bottom end, a first clockwise-threaded portion 122 located from a preset point in an intermediate portion to the bottom end, a counterclockwise-threaded portion 123 located from the head 11 to an upper end of the first clockwise-threaded portion 122, and a second clockwise-threaded portion 124 located in a lower end section of the first clockwise-threaded portion 122 and having one-third length of the first clockwise-threaded portion 122 and threads between two threads of the first clockwise-threaded portion 122. So the lower end section of the shank 2 is thus formed with double threads with a smaller pitch. In addition, the counterclockwise-threaded portion 123 has an outer diameter and the diameter of the lower end bigger than or equal to those of the first clockwise-threaded portion 122.

In using, superpose wooden or non-metallic articles on each other first. Next, keep the conical sharp point 121 of the screw 1 positioned vertically on the surface of an upper article to be screwed and then, start to turn the screw 1. Because the double threads formed in the lower end section has a smaller pitch, the screw 1 can be screwed into the articles easily and rapidly. In addition, the counterclockwise-threaded portion 123 can keep the screw 1 from being disengaged easily. Moreover, because the annular groove 112 is to be forcefully filled with a part of the upper article screwed while the shank 12 of the screw 1 is wholly engaged in the articles, the edge of the head 11 can therefore be immersed in the upper article, achieving a better effect of screwing.

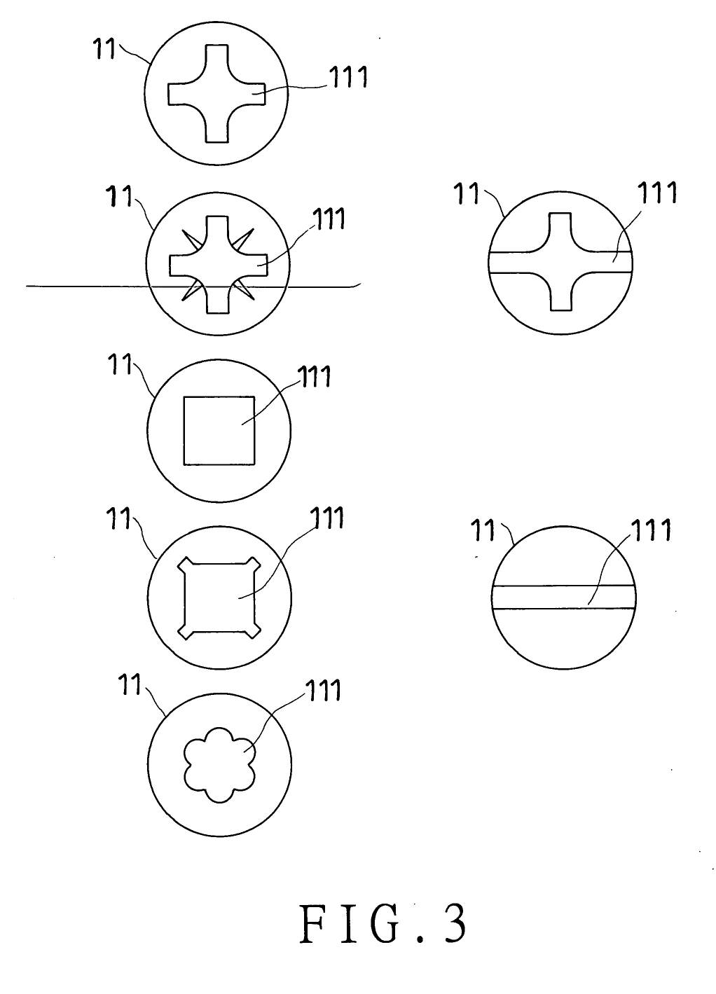

As shown in FIGS. 1 and 2, a second preferred embodiment of a screw 1 in the present invention has the same structure as the first embodiment does, except the shank 12 shaped into a triangular shank 125. Therefore, the first clockwise-threaded portion 122, the counterclockwise-threaded portion 123 and the second clockwise-threaded portion 124 are all shaped triangular, so that their threads are to contact with the articles screwed by three points only, causing a reduction of resistant force caused by articles to be screwed together.

The present invention has the following advantages as can be seen from the foresaid description.

1. The screw 1 can be screwed into articles easily and rapidly because the double-threaded portion formed in the lower end section has a smaller pitch.

2. The triangular shanks 125 of the screw 1 can keep three points contact with the articles screwed together owing it its shape, decreasing resistant force caused by the articles for quicker screwing.

3. The clockwise and counterclockwise threads of a screw are to counterbalance each other, so suppose all of the first and second clockwise-threaded portions 122 and 124 and the counterclockwise-threaded portion 123 receive a one-way vibration. The first and second clockwise-threaded portions 122 and 124 are to be screwed outward, but the counterclockwise-threaded portion 123 is to be screwed inward to counterbalance the screwing force of the first and the second clockwise-threaded portions 122 and 124, preventing the screw 1 from disengaged from the articles.

4. When the shank 12 of the screw 1 is wholly moved into the articles to be screwed together, the annular groove 112 is forcefully filled with a part of the upper article, keeping the edge of the head 11 immersed in the article to achieve a better effect of screwing.

While the preferred embodiment of the invention has been described above, it will be recognized and understood that various modifications may be made therein and the appended claims are intended to cover all such modifications that may fall within the spirit and scope of the invention.

What is claimed is:

1. A screw comprising:
a head; and
a shank extending down from said head and provided with a first clockwise-threaded portion with from a preset point in an intermediate portion to the bottom end, a counterclockwise-threaded portion from an upper end of said first clockwise-threaded portion to said head, and a second clockwise-threaded portion formed in a lower end section of said first clockwise-threaded portion and having the one-third length of said clockwise-threaded portion and threads located between two threads of said clockwise-threaded portion.

2. A screw as claimed in claim 1, wherein said shank is shaped triangular.

3. A screw as claimed in claim 1, wherein said counterclockwise-threaded portion has an outside diameter and the diameter of a lower end bigger than or equal to those of said first clockwise-threaded portion.

4. A screw as claimed in claim 1, wherein said head is provided with an annular groove around the circumference of its bottom.

5. A screw as claimed in claim 1, wherein said shank is provided with a conical sharp point at the bottom end.
